(19) United States
(12) Patent Application Publication
(10) Pub. No.: US 2013/0206832 A1
(43) Pub. Date: Aug. 15, 2013

(54) ELECTRONIC MEDIA MANAGEMENT SYSTEM WITH EXTERNAL REFERENCES

(71) Applicant: Pink Zulu Labs, Inc., (US)

(72) Inventor: Kaz Hashimoto, Jackson Hole, WY (US)

(73) Assignee: PINK ZULU LABS, INC., San Francisco, CA (US)

(21) Appl. No.: 13/764,712

(22) Filed: Feb. 11, 2013

Related U.S. Application Data
(60) Provisional application No. 61/598,769, filed on Feb. 14, 2012.

(51) Int. Cl. G06F 17/30

(52) U.S. Cl. CPC G06F 17/30244
USPC 235/375

(57) ABSTRACT

A media management system provides electronic access to the original media (or a version based on the original media) for people of who access the media in printed/published (paper or electronic) matter. In one example embodiment, a photograph will be printed (on paper or electronically) with a unique code (e.g., a bar code, QR code, or other type of code). A user can scan that code with a code reader (e.g., on a mobile telephone, laptop, dedicated code reader, or other device). The code is then used to access the photograph within a media management system such that the user's computing device automatically opens the photograph in a photo editor. The user can optionally edit, resize and/or re-format the photograph. The edited (or unedited) photograph can be sent to others, posted on social media (or other types of) sites, presented on web pages, printed, incorporated in other projects, etc.

This application claim the benefit of U.S. Provisional Application 61/598,769, “Electronic Media Management System With External References,” filed on Feb. 14, 2012, incorporated herein by reference in its entirety.

### BACKGROUND OF THE INVENTION

1. Field of the Invention

The present invention relates to technology for managing electronic media.

2. Description of the Related Art

The typical work flow is to take photographs with a digital camera, store the photographs on a memory card in the camera, transfer the photographs from the memory card to a computer when the event has completed and the user has returned home or to the office, edit the photographs using editing software on the digital files, store the digital files on the user's computer, and distribute the photos.

In many cases, photographs are distributed by sending printed matter that includes the photographs or including the photographs within other media. For example, a photograph may be used to print a post card, page in a magazine, image on clothing, billboard, etc. The image can also be distributed in online or other electronic media, or incorporated in video, art projects, etc. In many situations, the owner of the photograph is willing to allow viewers of the printed matter to access the original photograph (or something based on the original photograph). However, there is no efficient and sufficiently robust mechanism for providing such access to the photographs for viewers of printed matter.

### BRIEF DESCRIPTION OF THE DRAWINGS

FIG. 1 is a block diagram of one embodiment of a system that can use and manage photographs.

FIG. 2 is a block diagram of computing device and a camera.

FIGS. 3A and 3B depict memory cards.

FIG. 4 is a block diagram of computing device and a camera.

FIGS. 5A and 5B depict memory cameras.

FIG. 6 is a flow chart describing one embodiment of a process for configuring a communications link.

FIG. 7 is a block diagram describing the functions of the snap engine.

FIG. 8 is a flow chart describing one embodiment of a process for working with a photograph.

FIG. 9 is a flow chart describing one embodiment of a process for re-mixing and posting photographs in a collaborative environment.

FIG. 10 is a flow chart describing one embodiment of a process for accessing a photograph from a feed.

FIG. 11 is a flow chart describing one embodiment of a process for posting a photograph to a feed.

FIG. 12 shows relationships between posts.

FIG. 13 is a block diagram of a mobile telephone computing device.

FIG. 14 is a block diagram of a computing device.

FIG. 15 is a flow chart describing one embodiment of a method for providing electronic access to the original photograph (or a version based on the original media) to entities who access the photograph (or other type of media) in printed matter.

FIGS. 16A and 16B show two sides of a postcard.

FIG. 17 depicts a poster.

### DETAILED DESCRIPTION

The technology described herein is directed to an efficient and robust system that provides electronic access to the original photograph (or a version based on the original photograph) for people of who view the photograph in printed (paper or electronic) matter, as described above. In one example, embodiment, a photograph will be printed (on paper or electronically) with a unique code (e.g., a bar code, QR code, or other type of code). A user can scan that code with a code reader (e.g., on a mobile telephone, laptop, dedicated code reader, or other device). The code is then used to access the photograph within a media management system such that the user's computing device automatically opens to a photo editor with the photograph (e.g., JPG, BMP, TIF, RAW or any other format suitable for photographs) open. The user can optionally edit, resize and/or re-format the photograph. The edited (or unedited) photograph can be sent to others, posted on social media (or other types of) sites, presented on web pages, printed (in such physical forms as paper prints, posters, mugs, etc.), incorporated in other projects, etc.

The technology described herein is not limited to photographs, and can be used with other types of media. For example, rather than photographs, the technology described herein can be applied to music, videos, art, etc. One use example includes a still image from a music video being printed in a magazine advertisement with a QR code. A user scans the QR code, and the music video is presented positioned on that frame, from which point the user can edit or view the music video, edit the frame further as a still image, etc.

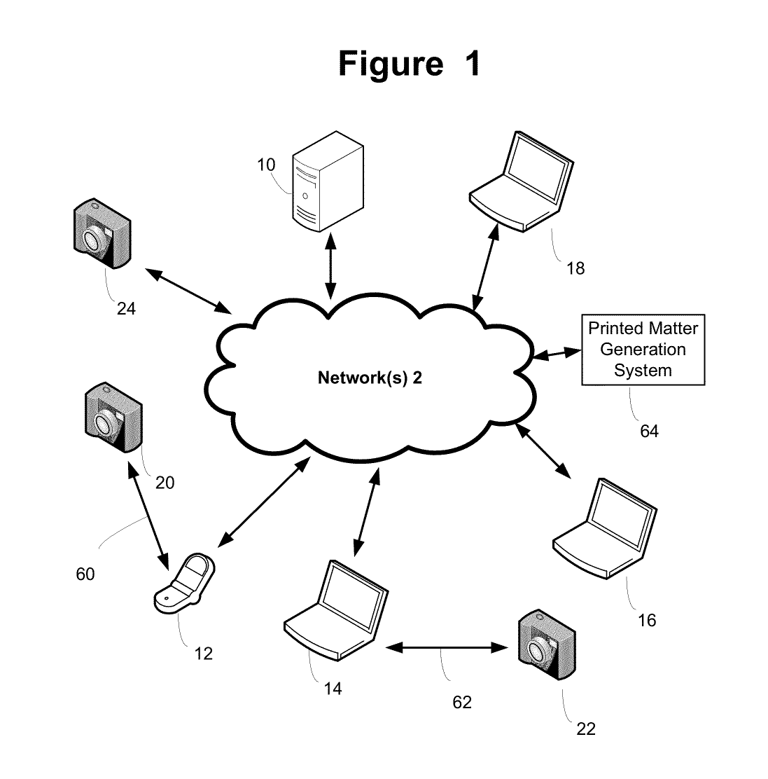

FIG. 1 shows network(s) 2 connected to various computing devices. In one embodiment, network(s) 2 can be the Internet and/or one or more local area networks, wide area networks, wireless networks, etc. FIG. 1 also depicts server 10, which can include one or more computing devices that are load balanced and behind firewalls, etc. Mobile computing device 12 is in communication with server 10 via network(s) 2. Mobile computing device 12 can be a smart cellular telephone, tablet computing device or other mobile computing device. FIG. 1 also shows computers 14, 16 and 18, which can include desktop computers, laptop computers, tablet computers, handheld computing devices, mobile cellular telephones, or other computing devices. In one embodiment, computing devices 12, 14, 16 and 18 can all communicate with server 10 via network(s) 2.

FIG. 1 also shows digital cameras 20, 22 and 24. These digital cameras can represent any make or model of still or video cameras. Digital camera 20 is shown to be in communication (unidirectional communication or bidirectional communication) with mobile computing device 12. Digital camera 22 is shown to be in communication (unidirectional communication or bidirectional communication) with computer 14. Digital camera 24 can be in communication (unidirectional communication or bidirectional communication) with server 10, mobile computing device 12, computer 14, computer 16 or computer 18 via network(s) 2. FIG. 1 also shows Printed Matter Generation System 64 that can communicate with server 10, computer 14, computer 16 or computer 18 via network(s) 2. The function of Printed Matter Generation System 64 is discussed below.

In operation, cameras 20, 22 or 24 (or other cameras) are used to take photographs. These photographs are then provided to a photograph management system that facilitates distribution, storage, editing and collaboration of the photographs. In one embodiment, the photograph management system is provided with central control and storage using server 10. Any of computing devices 12, 14, 16 and 18 can provide photographs to server 10, retrieve photographs from server 10, edit photographs, and send photographs to any of the other computing devices.

To more quickly and efficiently move photographs from cameras 20, 22 and 24 to the photograph management system, technology is described for providing a wireless transmission link from the photograph storage device (which can be the camera itself or also include a memory card in or out of the camera) to any one of computing devices 12, 14, 16 and 18. Additionally, the system can automatically configure that transmission link, as described below and in U.S. patent application Ser. No. 13/720,085, “Auto Configurable Transfer and Management System,” incorporated herein by reference in its entirety. For example, FIG. 1 shows a wireless transmission link 60 between camera 20 and mobile computing device 12, and a wireless transmission link 62 between camera 22 and computing device 14. Additionally, camera 24 can communicate wirelessly via the Internet to any of the computing devices depicted in FIG. 1.

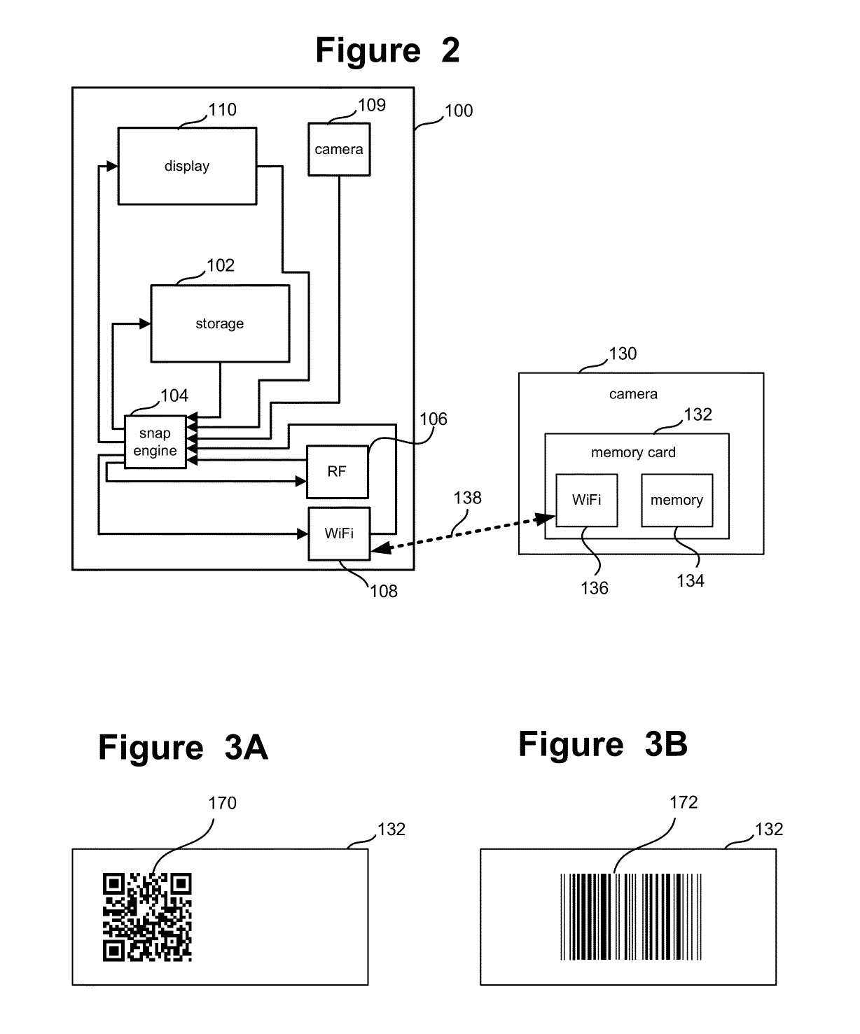

FIG. 2 provides a more detailed block diagram of components of a computing device 100 that has a wireless transmission link 138 to camera 130. Computing device 100 of FIG. 2 can be mobile computing device 12, computing device 14, computing device 16 or computing device 18 of FIG. 1. Camera 130 of FIG. 2 can be camera 20, 22 or 24 of FIG. 1.

Computing device 100 of FIG. 2 includes a storage system 102 which can include flash memory, EEPROM, hard disc drive, other nonvolatile memory, RAM, and/or other storages devices. Computing device 100 also includes snap engine 104 which can be implemented in software only, hardware only or a combination of software and hardware. Snap engine 104 performs the methods described below. Any software that implements snap engine 104 will be stored on a processor readable storage device and run on a processor. Computing device 106 also includes a RF transceiver which can receive and transmit RF signals (such as cellular phone signals). A WiFi transceiver 108 is also included which can communicate on a WiFi network. For purposes of this document, WiFi can include Bluetooth and other RF communication.

Computer 100 also includes a camera 109. In one embodiment, camera 109 includes a charge-coupled device (CCD) with one or more lenses to capture images in various formats and resolutions. Computing device 100 also includes a display 110 which can be any display known in the art. In one embodiment, storage 102, RF transceiver 106, WiFi transceiver 108, camera 109 and display 110 can all communicate data to snap engine 104 and receive data from snap engine 104. For example, storage device 102, RF transceiver 106, WiFi transceiver 108, camera 109 can all act as input sources of photographs. Snap engine 104 can act on those photographs (edit the photographs, resample the photographs, change resolution of the photographs, annotate the photographs, add captions, etc.). The output of the actions taken by snap engine 104 can be provided to RF transceiver 106 and WiFi transceiver 108 for eventual transmission to other devices, such as server 10 via the Internet (and/or other network). In one embodiment, computer 100 will also include an Ethernet connection for wire based communication. The output photograph of snap engine 104 can also be provided on the display 110.

Camera 130 includes a memory card 132 for storing photographs taken by camera 130. In one embodiment, memory card 132 includes a memory system 134 and a WiFi transceiver 136. In one embodiment, memory system 134 is a flash memory system; however, other nonvolatile storage technologies can also be used. Memory card 130 can be any standard format known in the art including Compact Flash, SD, Mini-SD, XD, Memory Stick, Memory Stick Pro and other formats.

Transmission link 138 will be created, automatically configured, and used to transmit photographs between WiFi transceiver 108 of computing device 100 and WiFi transceiver 136 of memory card 132 so that photographs are transferred from memory system 134 on memory card 130 to computing device 100 for storage 102 and snap engine 104. In one embodiment, wireless link 138 will be automatically configured by computing device 100. In that scenario, computing device 100 will need to know the identification of memory card 132 to perform the auto configuration. In one embodiment, a user will manually type in a unique (or non-unique) ID for memory card 132 into computing device 100. In another embodiment, computing device 100 will automatically sense the ID from a surface of or transmission from memory card 132. For example, FIG. 3A shows the outside surface of memory card 132 including a QR code 170. Computing device 100 can take a photograph of QR code 170 using camera 109. A unique identification (or identification that is not unique) can be embedded within QR code 170. Additionally, QR code 170 can include various configuration parameters including the SSID for a wireless network, password for authenticating in order to get access to the wireless network and a MAC address for WiFi transceiver 136. FIG. 3B shows another embodiment of memory card 132 including a barcode 172. In this embodiment, computing device 100 will take a photograph of barcode 172 using camera 109. The barcode will be decoded to determine the information described above. In other embodiments, the system can read the codes using other types of sensors including IR and RFID sensors, in order to obtain the configuration parameters. Once computing device 100 has the configuration parameters, computing device 100 will automatically configure the WiFi network connection 138 between transceiver 136 and transceiver 108.

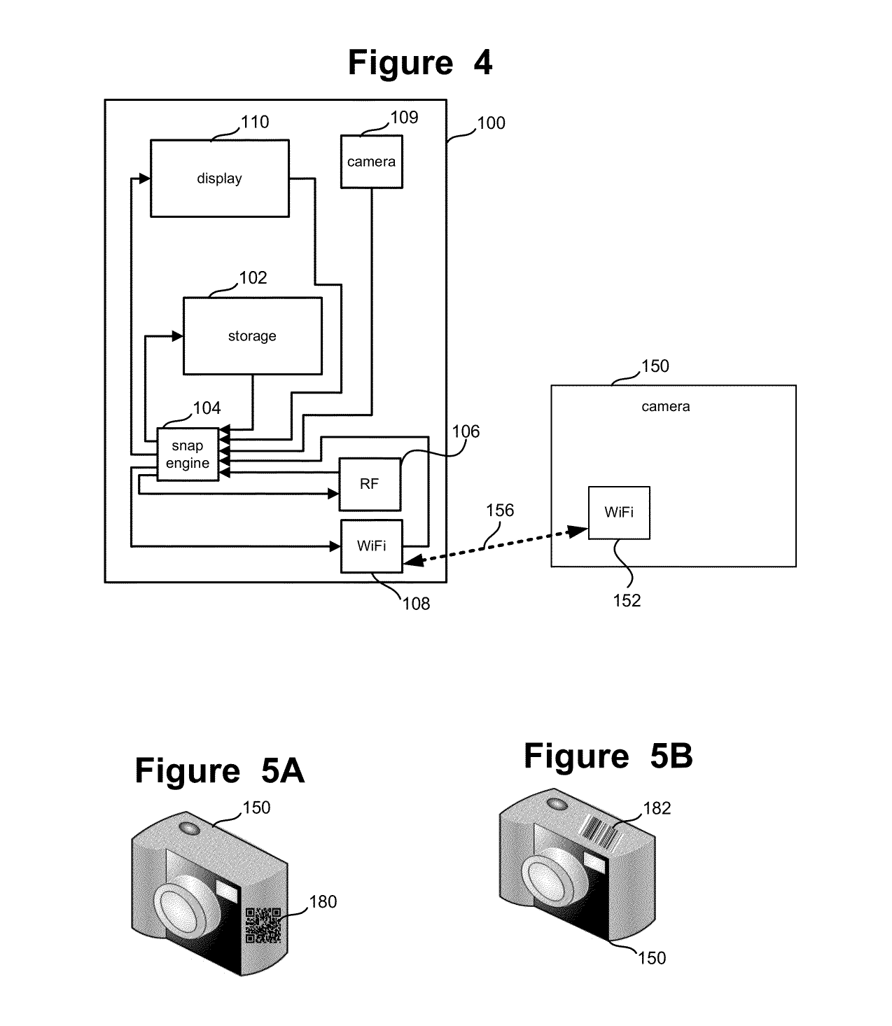

FIG. 4 shows another embodiment which includes camera 150 in communication with computing device 100. In this embodiment, camera 150 has a WiFi transceiver 152 built into camera 150 which will establish a link 156 with WiFi transceiver 108 of computing device 100. Therefore, camera 150 can be used with a standard memory card that does not include WiFi technology or memory embedded in camera 150. The embodiments of FIGS. 2 and 4 both include a WiFi transceiver in a photograph storage device. In the embodiment of FIG. 2, the photograph storage device is the memory card while in the embodiment of FIG. 4 the photograph storage device is the camera. Even if camera 150 stores photographs on a memory card within camera 150, it is still a photograph storage device for purposes of this document. FIG. 5A shows an embodiment where camera 150 includes a QR code 180 on the outside surface of the camera. FIG. 5B shows and embodiment of camera 150 with the barcode 182 on the outside surface of camera 150. As discussed above, computing device 100 will take a photograph of the QR code 180 or barcode 182 and identify the data encoded within those codes.

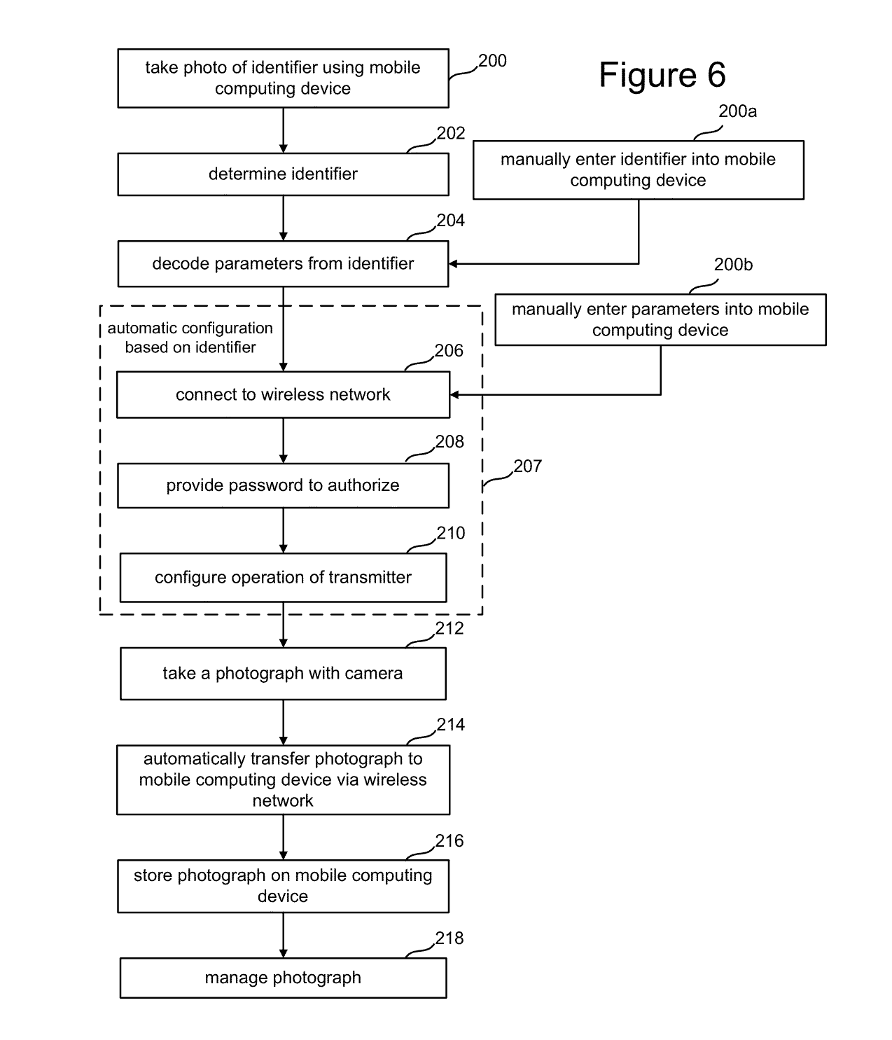

FIG. 6 is a flowchart describing the operation by the snap engine for automatically configuring the transmission links discussed above (e.g., transmission link 138 and/or transmission link 156). In step 200, a computing device (e.g., mobile computing device 12) will be used to take a photograph of an identifier. For example, mobile computing device 12 will be used to take a photograph of a QR code, bar code or other type of code. In step 202, the mobile computing device will determine the identifier encoded in the QR code. In step 204, the mobile computing device will decode parameters from the identifier. For example, the QR code may encode a number. That number may include the indication of an SSID, WEP password (or other authentication password), and/or MAC address. Note that FIG. 6 also shows an alternative embodiment (step 200A), where the user manually enters the identifier into the mobile computing device.

After decoding the parameters, the mobile computing device (e.g., snap engine) will automatically configure the transmission link based on the parameters from the identifier (step 207). For example, in step 206, the mobile computing device will connect to the wireless network being broadcast by the WiFi transceiver of the memory card or camera (or other storage device). In step 208, the mobile computing device will provide a password to authorize communication on that WiFi network (assuming encryption or other security). In step 210, operational parameters can be configured. For example, the WiFi transceiver on the memory card or digital camera can be configured to indicate how long the transceiver should stay on after taking a photograph, how many photographs should be transmitted at the same time, whether to send videos or not, whether to send RAW and/or JPG photographs, renaming the SSID, whether photographs that have been transmitted should be automatically erased, whether transmission should be manual, whether transmission should start automatically if the card is X % full. Other parameters can also be configured. In one embodiment, the mobile computing device can show a user interface to the user and allow the user to manually change any of the parameters in step 210.

In step 212, the digital camera (e.g., camera 130 or camera 150) will be used to take a photograph. In step 214, that photograph is automatically transferred to the mobile computing device via the wireless link (the wireless network) that was configured in step 207. In step 216, the photograph that was transmitted will be stored on the mobile computing device. In step 218, the photograph will be managed (as discussed below). As mentioned, photographs can be transmitted automatically immediately after being captured, after a card is X % full, after a camera is idle, after Q number of photographs are captured, etc.

Note that a computing device can also have an on-board camera so that it can take and store photographs without using the wireless link. Additionally, photographs can be manually transferred on to a computing device via card reader, network, etc.

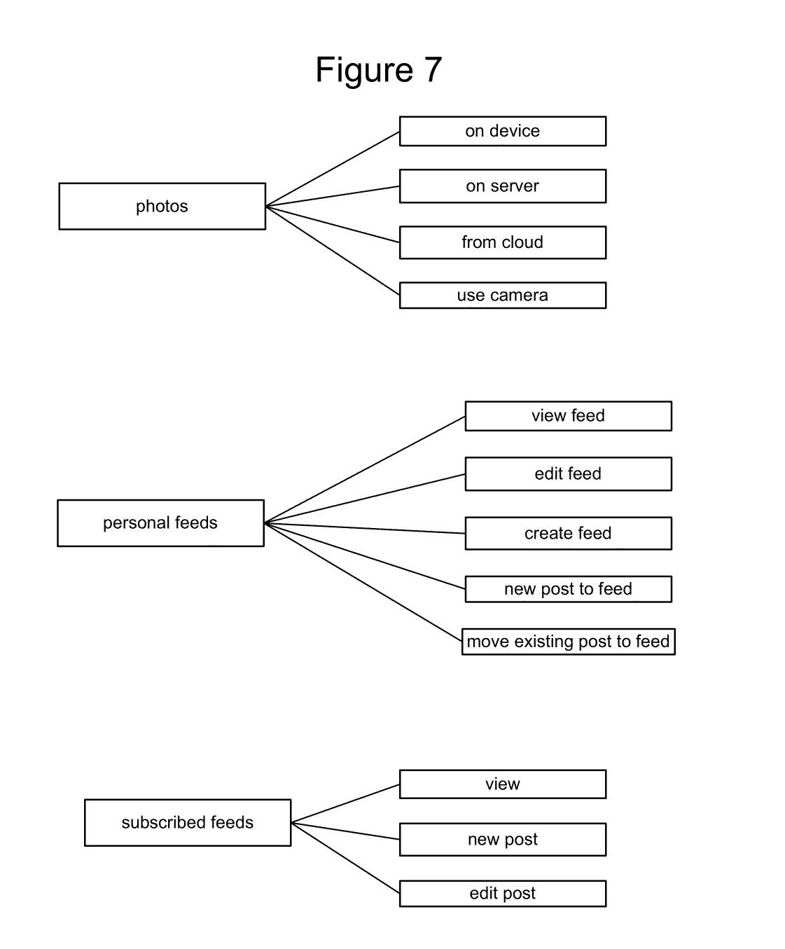

In one embodiment, snap engine 104 is used to manage photographs (step 218). FIG. 7 shows three sets of functions that can be performed using snap engine 104 as part of managing photographs (step 218). For example, photographs can be accessed on the mobile computing device, on server 10, from any storage on the cloud, or from the camera on the mobile computing device. All these represent sources of photographs for the photograph management system implemented by snap engine 104 and server 10.

The photograph management system includes the notion of feeds and posts. In one embodiment, a feed is a repository of photographs stored on server 10 that can be accessed by various computing devices and can be edited (e.g., re-mixed) by various users using the various computing devices In one embodiment, posts are photographs and remixes of photographs sent by any means described herein to a feed. A post consists of visual media (digital photo, digital video, etc.) and various other metadata describing the current state of that media and the history of interactions with that media (by humans and automatons), which determines how the media shall be presented to the user at the current state, or any previous states. More details about remixes are described below. Feeds can have actions associated with them. For example, a feed can be set up so that any time a photograph is posted to the feed, a copy of that photograph is automatically sent to a social network page, web site, photo printing service, e-mail service, text message service, photo editing service, etc. FIG. 7 shows that a user can have personal feeds which are feeds set up by the user and owned by the user. A user can view any of the personal feeds, edit the personal feeds, create personal feeds, make new posts to personal feeds and move existing posts into different personal feeds. A post is a submission to a feed of a photograph, comments on the photograph and metadata for that photograph. More details about posts are described below.

In addition to personal feeds, a user can subscribe to feeds owned by others (aka subscribed feeds). With subscribed feeds, the user can view the subscribed feeds, create new posts to the subscribed feeds, and edit existing posts in the subscribed feeds. Some embodiments will require permissions to perform various functions on subscribed feeds.

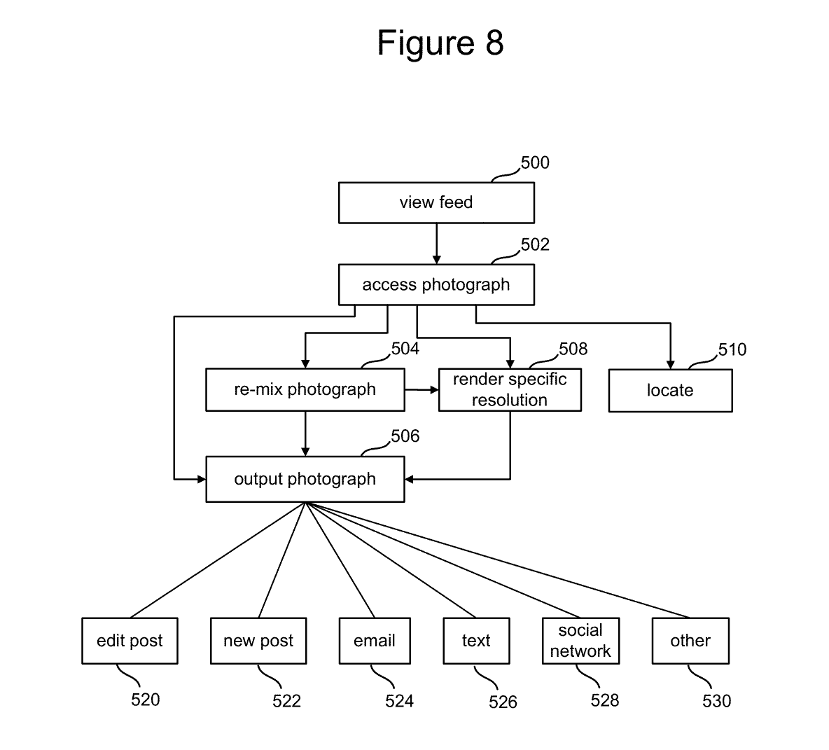

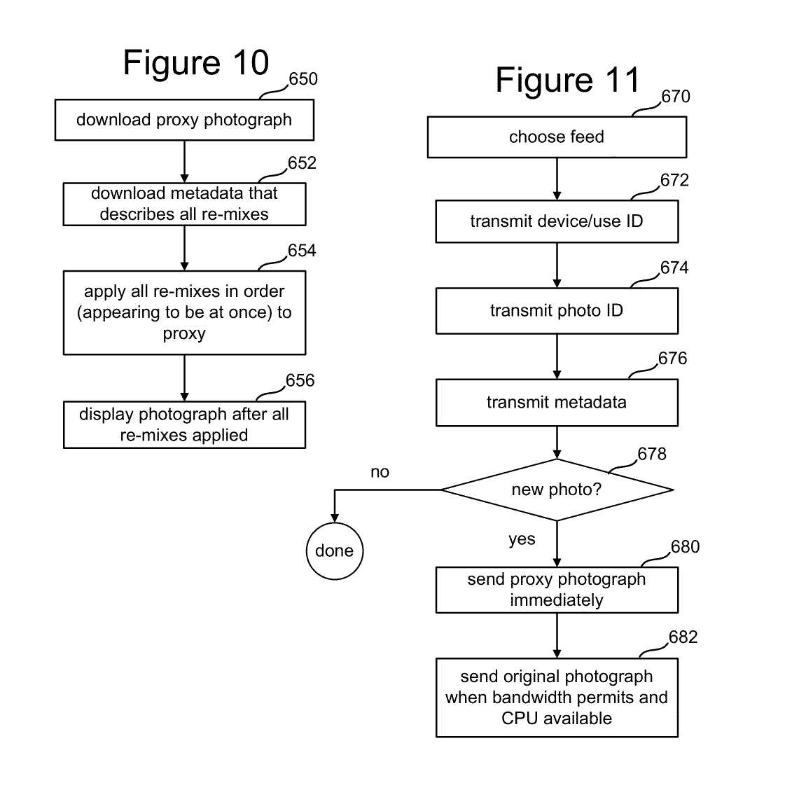

FIG. 8 is a flow chart describing one embodiment of a process performed by the snap engine when accessing a feed. Operating a user interface on any of the mobile computing devices described above, a user can choose to access feeds and choose one particular feed to access. That feed will be provided to the user for viewing in step 500. One embodiment of viewing a feed includes downloading a set of thumbnails for each photograph in the feed and displaying those thumbnails to the user. The user can choose any of those thumbnails in step 502 to access the photograph associated with that thumbnail. In one embodiment, step 502 includes displaying a full screen or other larger than a thumbnail version of the photograph. More details of step 502 are provided in FIG. 10.

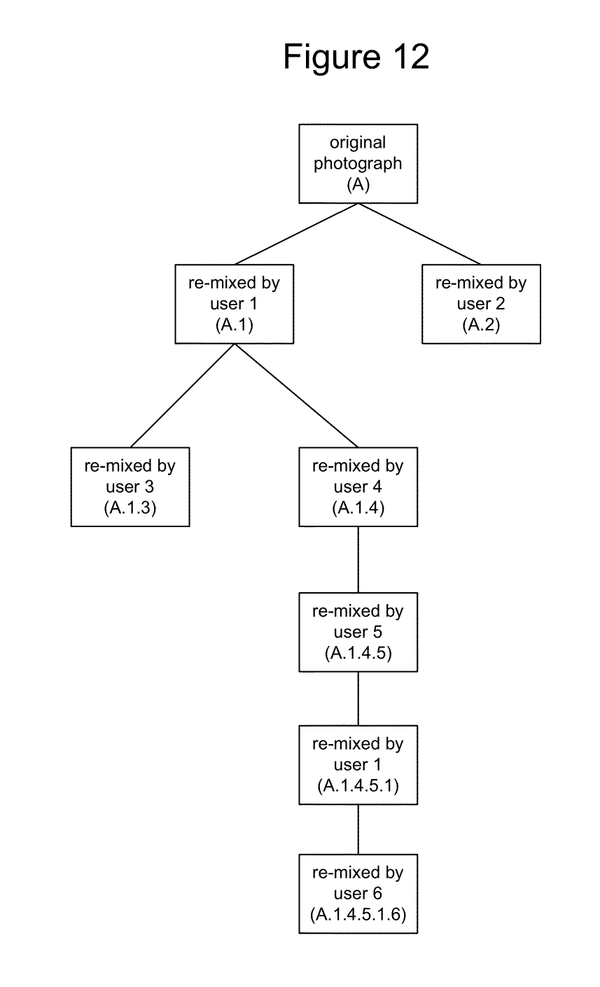

Once the user has accessed a photograph, the user can choose to remix the photograph in step 504, render specific resolution versions of the photograph in step 508, locate where the photograph is in the photograph hierarchy (see FIG. 12 and discussion below) or output the photograph in step 506. Remixing the photograph is analogous to editing a photograph. The user can crop, resize, rotate, transform (automatically, manually or with preset films), or otherwise edit the photograph. When re-mixing (504), the user can also transition to a process for render specific resolution versions of the photograph (508). In one embodiment, the Snap Engine will include a Remixer module to re-mix the photograph and a Flex-Render module to render specific resolution versions of the photograph. In some embodiment, step 502 includes displaying the accessed photograph in the Remixer module.

Outputting the photograph in step 506 includes editing the existing post in step 520. For example, a photograph may be part of an existing post. In step 504, the user can remix the photograph and save the remixed photograph into the existing post; therefore, editing the existing post in step 520. Alternatively, outputting the photograph can include posting the photograph to a feed in a new post (step 522). Additionally, the user can e-mail the photograph (step 524), send the photograph in a text message (step 526), display the photograph on a social networking site (step 528), or otherwise transmit the photograph to another system in step 530 using any other means known in the art.

The photograph management system discussed herein is somewhat collaborative in that users can post photographs to feeds and other users can access the photographs in those feeds, remix the photographs and post the remixes. Other users can then remix the remixes and so on. This way various people can edit other people's photographs and a whole community can see how these photographs have been edited. This allows the sharing of artistic ideas and improving of various photographs for all to benefit. Users (with proper permissions, if permissions are set up) are free to access the photograph at any of the steps of remixing such that a user can access the original photograph before anyone remixed or the photograph at any step between various users who have remixed.

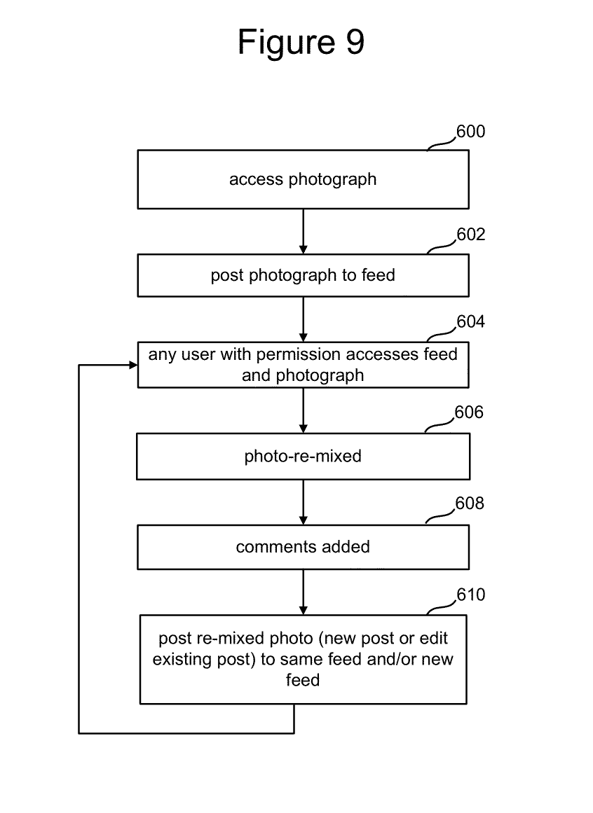

FIG. 9 is a sample process for collaboratively re-mixing of photographs. Other variants of the process of FIG. 9 can also be included within the technology described herein. In step 600, a photograph is accessed. For example, the photograph can come from a camera, sensor, memory, etc. That photograph is then posted to a feed in step 602. In step 604, any user with permission to access the feed can then access the post which includes the photograph. In step 606, the other user who accessed the post/photograph from the feed can remix the photograph and then add comments in step 608. In step 610, the remixed photograph is posted either to a new post or by editing an existing post. The post can be to the same feed and/or a different feed. The process of FIG. 9 will then loop back to step 604 and any other user (or the same user) who has permission to access the feed can then access the remixed or original photograph and repeat the process. The photograph can be remixed many times by the same user or different users. Each time a user uploads a new remix of the photograph in a new post, the photograph management system will allow for old/other versions of the photographs to remain accessible. As will be explained below, all remixing of each photograph is performed using a proxy of the original image, which is stored safely on server 10. Therefore, the original image will not be destroyed or lost. Remixing and commenting can be done independently of each other. Making a comment does not require a remix—it just annotates the original image.

FIG. 10 is a flowchart describing one embodiment of a process performed by the snap engine for accessing a photograph that was posted (see step 600 of FIG. 9 and step 502 of FIG. 8). In step 650, a proxy photograph is downloaded from the server to the snap engine. In one embodiment, the proxy photograph is a 600×600 pixels resolution version of the photograph in the post that the user accessed. In some embodiments, the mobile computing device requesting the proxy photograph will indicate its display resolution and the proxy photograph can then be tailored to the resolution of the display for the mobile computing device (or other computing device). In step 652, metadata for the photograph in the post is downloaded. In one embodiment, when a photograph is remixed, the original photograph is not changed. Rather, the system will store metadata that indicates what all the changes (remixes) are. The metadata could include instructions on how to crop, how to rotate, how to transform, how to edit pixels, etc. In step 654 of FIG. 10, the snap engine for the mobile computing device that downloaded the proxy photograph and the metadata will apply all the metadata for all the remixing in order (but appearing to be at once) to the proxy and photograph. For example, if a photograph has been edited by four different people, all four sets of edits will be made in step 654. In step 656, the photograph (after all remixes) is displayed by the mobile computing device. In one embodiment, the photograph is displayed in the Remixer module. In other embodiments, the photograph is displayed is another rendering engine.

FIG. 11 is a flowchart describing one embodiment of a process performed by the snap engine for posting a photograph (see step 610 of FIG. 9). In step 670, the user will choose a feed from the user's feeds and those feeds that the user subscribed to and has permission to post to. Alternatively, the user can choose a new feed. In step 672, the user's computing device will transmit a device ID and/or a user ID to server 10. In step 674, the user's mobile computing device will transmit an identification of the photograph to the server 10. In some embodiments, the mobile computing device can also transmit a post ID for a photograph that already exists in a post. In step 676, metadata for any remixing the user performed (see step 606 of FIG. 9) is transmitted from the user's computing device to the server 10. If this is not a new photograph (678), meaning that the photograph already exists in the feed, then the process is complete because the feed has all the information it needs for the new post. If this is a new photograph for this feed, then in step 680, a proxy photograph will be immediately transmitted to the server 10. In one embodiment, the proxy photograph is a 600×600 pixels resolution version of the original photograph. In step 682, the full resolution version (i.e. the original) of the photograph will be transmitted at a later time when bandwidth permits and/or the CPU is available.

As discussed above, feeds can be viewable by multiple people. A user can log into a feed, view all the photographs (posts of themselves and others), choose a photograph (choose another's post or their own post), and remix that post. Therefore, photographs can be remixed by multiple people serially or in parallel. FIG. 12 shows an example tree of how a photograph can be remixed. For example, in the original photograph it is posted to a feed. FIG. 12 represents original photograph as photograph A. User 1 then accesses the feed as described above, remixes photograph A as described above to create photograph A.1. Photograph A.1 is then posted (in a new post) to the same feed. In parallel, user 2 will access the same original photograph A from the same post and remix that photo in a different way to create new remixed photo A.2. User 2 will post photo A.2 to the same feed.

After user 1 posts photograph A.1, user 3 and user 4 will both download photograph A.1, and both user 3 and user 4 will remix photograph A.1. User 3 will create photograph A.1.3, while user 4 will create photograph A.1.4. User 3 will post photograph A.1.3 to the same feed. User 4 will post photograph A.1.4 to the same feed. User 5 will then download and remix photograph A.1.4 to create photograph A.1.4.5. User 5 will post photograph A.1.4.5 to the same feed. User 1 (who created photograph A.1) will then access the post from user 5 to download photograph A.1.4.5. User 1 will remix photograph A.1.4.5 to create photograph A.1.4.5.1, and will then post that remixed photograph to the same feed. Subsequently, user 6 will access the post to obtain photograph A.1.4.5.1 and remix it. User 6 will then post the remixed photograph as photograph A.1.4.5.1.6.

When a user accesses the photograph management system (e.g., snap engine 104 or server 10), the user can choose to view a feed (see FIG. 7). When a feed is transmitted to the user's computing device, all the posts will be transmitted. Therefore, a user who accesses the feed that includes the photographs of FIG. 12 will see all the posts listed in FIG. 12. Therefore, a user with access to that feed can access any of the photographs A, A.1, A.2, A.1.3, A.1.4, A.1.4.5, A.1.4.5.1, or A.1.4.5.1.6, and can then remix any of those photographs. Therefore, even though another user may edit a first person's photograph, the first person's photograph still remains unchanged and a new remix will be provided to the community. As discussed above, each time a user remixes, the user will be remixing by manipulating a proxy photograph. The resulting photograph will not be provided back to the server 10, but instead will be represented by a post that includes the metadata for the remixing. In one embodiment, all the photographs and posts will be stored on server 10, and available to any of the computing devices with the appropriate snap engine 104.

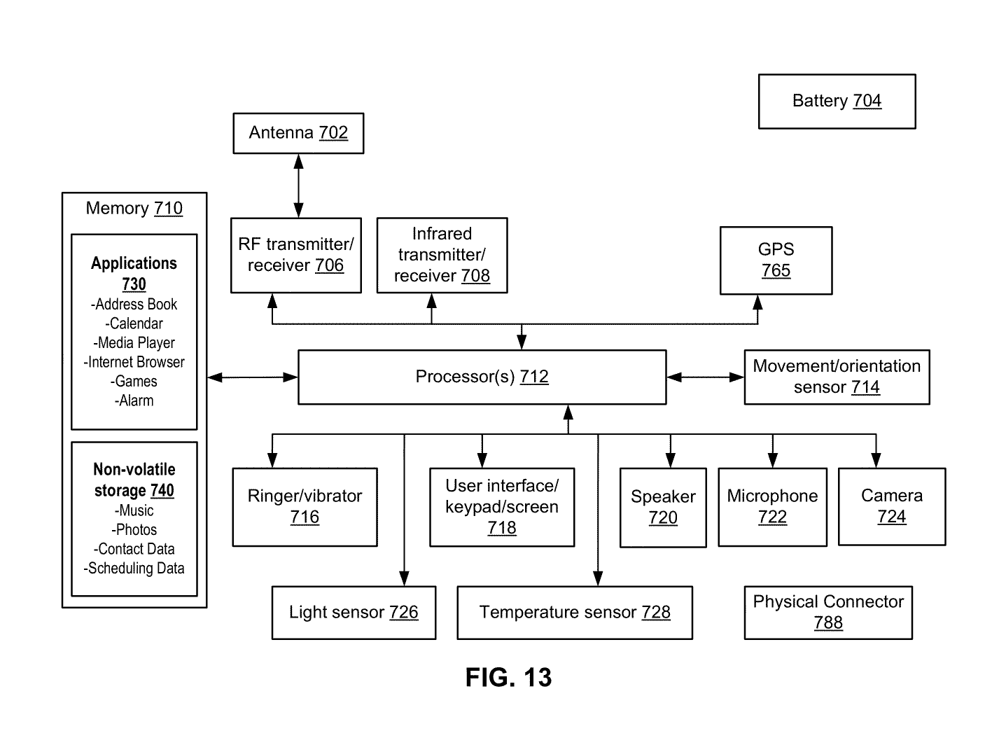

FIG. 13 is a block diagram of one embodiment of a mobile device 12. Mobile devices may include laptop computers, pocket computers, mobile telephones, personal digital assistants, tablet computers, and handheld media devices that have been integrated with wireless receiver/transmitter technology.

Mobile device 700 includes one or more processors 712 and memory 710. Memory 710 includes applications 730 and non-volatile storage 740. Memory 710 can be any variety of memory storage media types, including non-volatile and volatile memory. A mobile device operating system handles the different operations of the mobile device 700 and may contain user interfaces for operations, such as placing and receiving phone calls, text messaging, checking voicemail, and the like. The applications 730 can be any assortment of programs, such as a camera application for photographs and/or videos, an address book, a calendar application, a media player, an internet browser, games, an alarm application, and other applications. The non-volatile storage component 740 in memory 710 may contain data such as music, photos, contact data, scheduling data, and other files.

The one or more processors 712 also communicates with RF transmitter/receiver 706 which in turn is coupled to an antenna 702, with infrared transmitter/receiver 708, with global positioning service (GPS) receiver 765, and with movement/orientation sensor 714 which may include an accelerometer and/or magnetometer. RF transmitter/receiver 708 may enable wireless communication via various wireless technology standards such as Bluetooth® or the IEEE 802.11 standards. Accelerometers have been incorporated into mobile devices to enable applications such as intelligent user interface applications that let users input commands through gestures, and orientation applications which can automatically change the display from portrait to landscape when the mobile device is rotated. An accelerometer can be provided, e.g., by a micro-electromechanical system (MEMS) which is a tiny mechanical device (of micrometer dimensions) built onto a semiconductor chip. Acceleration direction, as well as orientation, vibration, and shock can be sensed. The one or more processors 712 further communicate with a ringer/vibrator 716, a user interface keypad/screen 718, a speaker 720, a microphone 722, a camera 724, a light sensor 726, and a temperature sensor 728. The user interface keypad/screen may include a touch-sensitive screen display.

The one or more processors 712 controls transmission and reception of wireless signals. In transmission mode, the one or more processors 712 provide voice signals from microphone 722, or other data signals, to the RF transmitter/receiver 706. The transmitter/receiver 706 transmits the signals through the antenna 702. The ringer/vibrator 716 is used to signal an incoming call, text message, calendar reminder, alarm clock reminder, or other notification to the user. In receiving mode, the RF transmitter/receiver 706 receives a voice signal or data signal from a remote station through the antenna 702. A received voice signal is provided to the speaker 720 while other received data signals are processed appropriately.

Additionally, a physical connector 788 may be used to connect the mobile device 700 to an external power source, such as an AC adapter or powered docking station, in order to recharge battery 704. The physical connector 788 may also be used as a data connection to an external computing device. The data connection allows for operations such as synchronizing mobile device data with the computing data on another device.

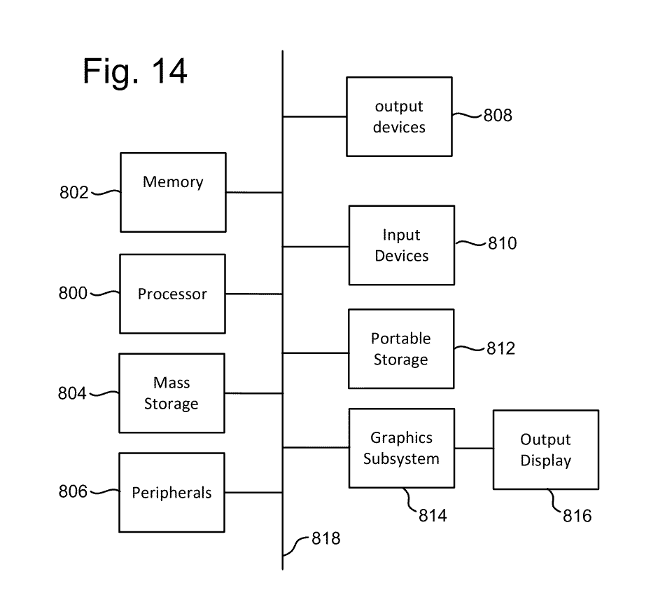

FIG. 14 illustrates a high level block diagram of a computer system which can be used for various components described above, including the server and other computers (e.g., 14, 16 and 18). The computer system of FIG. 14 includes one or more processors 800 and main memory 802. Main memory 802 stores, in part, instructions and data for execution by processor unit 800. If the system of the present invention is wholly or partially implemented in software, main memory 802 can store the executable code when in operation. The system of FIG. 14 further includes a mass storage device 804, peripheral device(s) 806, user input device(s) 810, output devices 808, portable storage medium drive(s) 812, a graphics subsystem 814 and an output display 816. For purposes of simplicity, the components shown in FIG. 14 are depicted as being connected via a single bus 818. However, the components may be connected through one or more data transport means. For example, processor unit 800 and main memory 802 may be connected via a local microprocessor bus, and the mass storage device 804, peripheral device(s) 806, portable storage medium drive(s) 812, and graphics subsystem 64 may be connected via one or more input/output (I/O) buses. Mass storage device 804, which may be implemented with a magnetic disk drive, an optical disk drive or a solid-state disk drive, is a non-volatile storage device for storing data and instructions for use by processor unit 800. In one embodiment, mass storage device 804 stores the system software for implementing the present invention for purposes of loading to main memory 802.

Portable storage medium drive 812 operates in conjunction with a portable non-volatile storage medium, such as a floppy disk, to input and output data and code to and from the computer system of FIG. 14. In one embodiment, the system software for implementing the present invention is stored on such a portable medium, and is input to the computer system via the portable storage medium drive 812. Peripheral device(s) 806 may include any type of computer support device, such as an input/output (I/O) interface, to add additional functionality to the computer system. For example, peripheral device(s) 806 may include a network interface for connecting the computer system to a network, a modem, a router, etc.

User input device(s) 810 provides a portion of a user interface. User input device(s) 810 may include an alpha-numeric keypad for inputting alpha-numeric and other information, or a pointing device, such as a mouse, a trackball, stylus, or cursor direction keys. In order to display textual and graphical information, the computer system of FIG. 14 includes graphics subsystem 814 and output display 816. Output display 816 may include a cathode ray tube (CRT) display, liquid crystal display (LCD) or other suitable display device. Graphics subsystem 814 receives textual and graphical information, and processes the information for output to display 816. Additionally, the system of FIG. 14 includes output devices 808. Examples of suitable output devices include speakers, printers, network interfaces, monitors, etc.

The components contained in the computer system of FIG. 14 are those typically found in computer systems suitable for use with the present invention, and are intended to represent a broad category of such computer components that are well known in the art. Thus, the computer system of FIG. 14 can be a personal computer, mobile computing device, workstation, server, minicomputer, mainframe computer, or any other computing device. The computer can also include different bus configurations, networked platforms, multi-processor platforms, etc. Various operating systems can be used including Unix, Linux, Windows, Windows Mobile, Windows Phone, Macintosh OS, iOS, Palm OS, Blackberry, and other suitable operating systems.

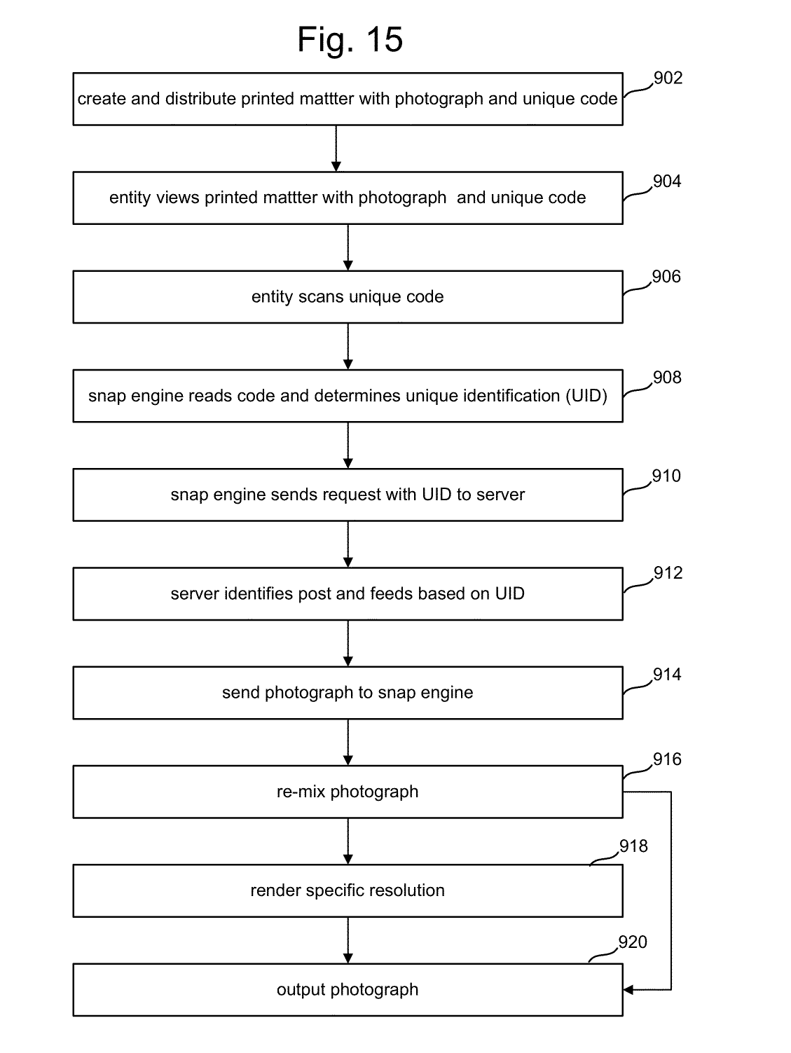

FIG. 15 is a flow chart describing one embodiment of a method for providing electronic access to the original photograph (or a version based on the original media) to entities who access the photograph (or other type of media) in printed matter. In step 902, printed matter is created using a photograph from one of the posts/feeds. For example, a photograph may be used to print a post card, a page in a magazine, an image on clothing, a billboard, etc. The image can also be distributed in online or other electronic media, or incorporated in video, art projects, etc. All of the above are considered printed matter. The printed matter is also distributed in retail stores, online, as part of giveaways or in any other manner. In one example, a user can post a photo to a feeds that is automatically sent to a printer. When the user created the post, the user added text to the post. In one option, the user adds two text fields: mailing address and salutation. The printer automatically prints a postcard of the photograph from the post, prints the submitted mailing address on the post card, prints the submitted salutation as the body of the postcard, and prints a unique QR code (or bar code or other type of code) as the unique code. The postcard is automatically mailed to the mailing address. In another example, a sports team will add a QR code to a team poster available for sale or given away for free at games.

FIG. 1 show Printed Matter Generation System 64 in communication with the various content generating devices and computing devices (including server 10) for receiving a photograph can creating a printed matter. Printed Matter Generation System 64 may include one or more printers, monitors, etc.

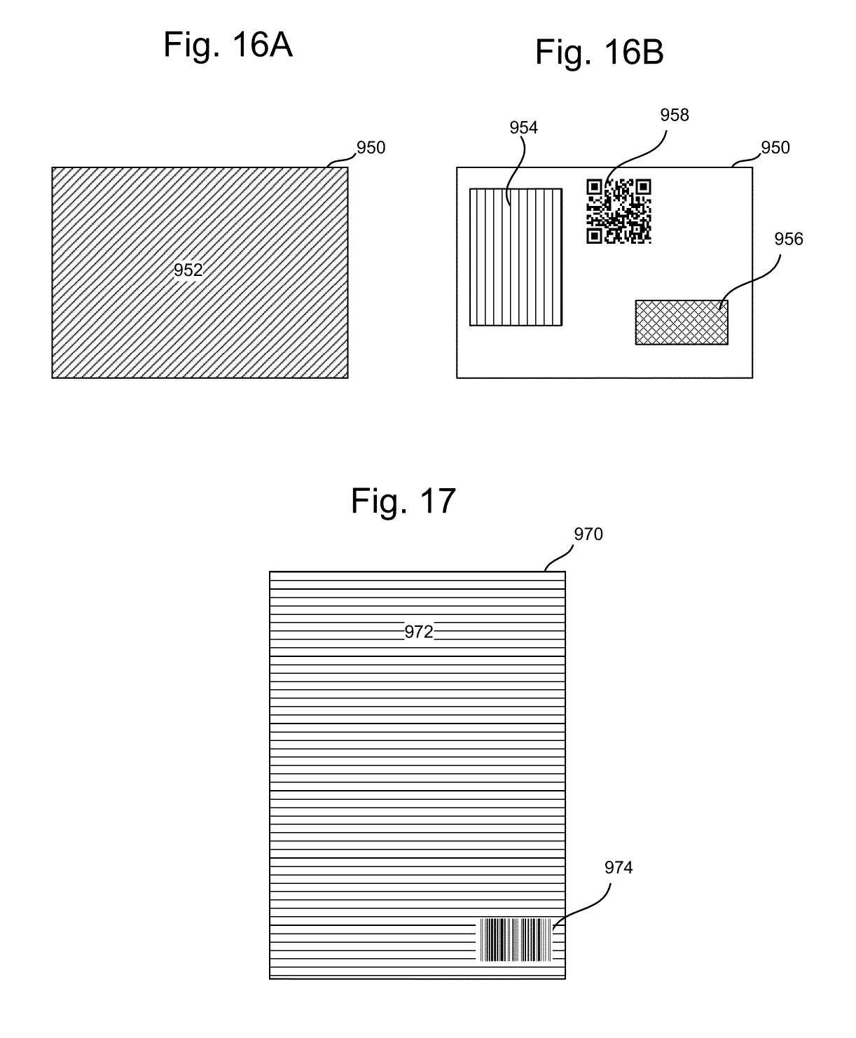

FIGS. 16A, 16B and 17 shows examples of printed matter. FIGS. 16A and 16B show two sides of a postcard. FIG. 16A shows the front of postcard 950 with photograph 952 printed thereon. FIG. 16B shows the back of postcard 950, with salutation 954, mailing address 956, and QR code 958 printed thereon. FIG. 17 depicts a poster made from photograph 972 and bar code 974.

In step 904 of FIG. 15, an entity (e.g., human or robotic device) views the printed matter with the photograph and unique code. For example, the recipient of the post card reads the cards and notices the QR code or a child receiving the free poster at a sports event notices the bar code on the poster. The entity scans the unique code in step 906. For example, a computing device (e.g., mobile computing device 12) that includes a software application that is compatible with the Media Management System described herein will be used to take a photograph of a QR code, bar code or other type of code. In some embodiments, that software application may include an instance of the snap engine Alternatively, a dedicated bar code or QR code reader can be used. In step 908, a code reader module of the software application that is compatible with the Media Management System described herein will read the code from the digital photograph taken in step 906 and decrypt/decode the code read to identify the unique identification (UID) represented by the QR code, bar code or other type of code. In some embodiments, the code will not be decrypted or a plain text UID will be displayed with the photograph. In step 910, the software application that is compatible with the Media Management System described herein sends the UID to server 10 with a request to obtain the photograph associated with the UID. In some embodiments, the snap engine sends the photograph of the code and the server identifies the UID. The photograph associated with the UID may be the original digital photograph used in the printed matter, a re-mixed version of the original digital photograph used in the printed matter, a re-sized (new resolution and/or new dimensions) version of the original digital photograph used in the printed matter, or a copy of the original digital photograph used in the printed matter. The photograph associated with the UID may be any of the versions based on the original, as explained above with respect to FIG. 12.

In step 912, server 10 (implementing the photo/media management system) uses the UID to access the photograph associated with the UID. In one example, the UID is an identification of a post, so server 10 uses the UID to access the post that includes the photograph. That post is part of a feed, so the server is accessing a post and a feed. In response, server 10 can send the post and/or the feed to the software application that sent the UID (or another application). In step 914, server 10 will send the photograph/post (and/or other media) and metadata identified by the UID to the software application that is compatible with the Media Management System described herein, which injects the photograph (or other media) into the snap engine in the entity's device that scanned the QR or bar code. One embodiment of step 914 includes performing the steps of FIG. 10, resulting in rendering of the photograph (e.g., photograph 952 of FIG. 16A or 972 of FIG. 17) in the Remixer module of the snap engine. In step 916, the entity can re-mix the photograph. For example, the entity can perform any photo editing known in the art. After re-mixing, the user can create a specific resolution version of the photograph in step 918. In step 920, the entity outputs the photograph. Note that step 918 is optional, and the entity can skip step 918 and proceed from the Remixer module directly to outputting the photograph in step 920.

Outputting the photograph in step 920 includes editing the existing post, saving the photograph to a new post in a new or existing feed (as per the discussion of FIG. 12), e-mailing the photograph, sending the photograph in a text message, display the photograph on a social networking site or web page, adding the photograph to a video, creating a new printed matter based on the photograph, making an art project based on the photograph, otherwise transmitting the photograph to another system or using any the photograph in any other means known in the art. The output can be rendered at resolutions and other parameters as necessary for the destination of the remixed media (social networking, print, greeting card, poster, etc.).

One embodiment includes a method for managing media, comprising: scanning a code in a printed matter in connection with a media item in the printed matter, the scanning is performed with a mobile computing device; sending a request for the media item from the mobile computing device based on the code; automatically receiving a version of the media item at the mobile computing device; and presenting the received version of the media item on the computing device.

One embodiment includes a computing apparatus, comprising: a storage device that stores code including a first storage unit of code; a communication interface; and one or more processors in communication with the storage device and the communication interface. The one or more processors cause a scanning of a code in a printed matter separate from the computing apparatus in connection with a media item in the printed matter. The one or more processors send a request for the media item from the mobile computing device based on the code. A version of the media item is received at the mobile computing device via the communication interface and stored in the storage device for presentation on the computing apparatus.

One embodiment includes a method for managing media, comprising: electronically receiving an identification of a media item at a media management system via a network, the identification is based on a code in a printed matter in connection with the media item in the printed matter; identifying a feed within a data structure that includes the media item based on the received identification; identifying a post in the feed that includes the media item within the identified feed based on the received identification; and electronically sending the media item to a source of the received identification.

One embodiment includes one or more processor readable storage devices having processor readable code embodied on said one or more processor readable storage devices, said processor readable code for programming one or more processors to perform a method comprising: scanning a code in a printed matter in connection with a media item in the printed matter, the scanning is performed with a mobile computing device; and automatically accessing the original photograph in a photo editor on the computing device, the original photograph is accessed from a media management system via network communication between the computing device and the media management system.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated.

What is claimed is:

1. A method for managing media, comprising:
scanning a code in a printed matter in connection with a media item in the printed matter, the scanning is performed with a mobile computing device;
sending a request for the media item from the mobile computing device based on the code;
automatically receiving a version of the media item at the mobile computing device; and
presenting the received version of the media item on the computing device.

2. The method of claim 1, further comprising:
distributing the media item using a media management system, the received version of the media item is received from the media management system.

3. The method of claim 2, wherein:
the distributing the media item comprises posting the media item to a feed of the media management system which automatically sends the media item to a third party service.

4. The method of claim 1, wherein:
the media item is a photograph.

5. The method of claim 1, wherein:
the code is a QR code; and
the method further comprises determining an identification based on the QR code, the request for the media item includes the identification.

6. The method of claim 1, further comprising:
receiving metadata for the version of the media item at the mobile computing device, the presenting the received version of the media item on the computing device comprises editing the received version of the media item based on the metadata, the presenting comprises outputting the received version of the media item after editing based on the metadata.

7. The method of claim 1, wherein the media item is a photograph and the method further comprises:
editing the photograph with a photo editor, the presenting the received version of the media item comprises displaying the photograph in the photo editor.

8. The method of claim 1, wherein:
the automatically receiving a version of the media item at the mobile computing device includes receiving an entire feed of media items at the mobile computing device in response to the request.

9. The method of claim 1, wherein:
the automatically receiving a version of the media item at the mobile computing device includes receiving one photograph from a data structure of multiple re-mixed versions of the photograph arranged in a tree structure.

10. A computing apparatus, comprising:
a storage device that stores code including a first storage unit of code;
a communication interface; and
one or more processors in communication with the storage device and the communication interface, the one or more processors cause a scanning of a code in a printed matter separate from the computing apparatus in connection with a media item in the printed matter, the one or more processors send a request for the media item from the mobile computing device based on the code, a version of the media item is received at the mobile computing device via the communication interface and stored in the storage device for presentation on the computing apparatus.

11. The computing apparatus of claim 10, further comprising:
an image sensor in communication with the one or more processors, the image sensor scans the code in the printed natter by taking a photograph of the code, the one or more processors read the code from the photograph and determine an identification for the media item from the code.

12. The computing apparatus of claim 10, wherein:
the received version of the media item is received from the media management system, and the one or more processors post the media item to a feed of the media management system which automatically sends the media item to a third party service.

13. The computing apparatus of claim 10, wherein:
the one or more processors receive metadata for the version of the media item and automatically edit the received version of the media item based on the metadata prior to presentation on the computing apparatus.

14. The computing apparatus of claim 10, wherein:
the one or more processors receive an entire feed of media items at the mobile computing device in response to the request.

15. The computing apparatus of claim 10, wherein:
the one or more processors receive one photograph from a data structure of multiple re-mixed versions of the photograph arranged in a tree structure.

16. A method for managing media, comprising:
electronically receiving an identification of a media item at a media management system via a network, the identification is based on a code in a printed matter in connection with the media item in the printed matter;
identifying a feed within a data structure that includes the media item based on the received identification;
identifying a post in the feed that includes the media item within the identified feed based on the received identification; and
electronically sending the media item to a source of the received identification.

17. The method of claim 16, further comprising:
identifying metadata for the media item, the metadata indicates a series of edits to the metadata; and
sending the metadata to the source of the received identification for the source of the received identification to edit the media item based on the metadata.

18. The method of claim 16, wherein:
the identifying the feed includes identifying a data structure of multiple re-mixed versions of the photograph arranged in a tree structure based on the identification.

19. The method of claim 16, further comprising:
receiving a new post from the source of the received identification to a feed which automatically sends the media item to a third party service.

20. One or more processor readable storage devices having processor readable code embodied on said one or more processor readable storage devices, said processor readable code for programming one or more processors to perform a method comprising:
scanning a code in a printed matter in connection with a media item in the printed matter, the scanning is performed with a mobile computing device; and
automatically accessing the original photograph in a photo editor on the computing device, the original photograph is accessed from a media management system via network communication between the computing device and the media management system.
